(19) United States
(12) Patent Application Publication
(10) Pub. No.: US 2024/0078580 A1
(43) Pub. Date: Mar. 7, 2024

(54) METHODS OF CREATING AN ONLINE SHOPPING MALL USING DOMAIN NAME EXTENSIONS

(71) Applicant: Morelove LLC, Wilmington, DE (US)

(72) Inventor: Leila Downs, Wilmington, DE (US)

(21) Appl. No.: 18/448,738

(22) Filed: Aug. 11, 2023

Related U.S. Application Data
(60) Provisional application No. 63/403,746, filed on Sep. 3, 2022.

(51) Int. Cl. G06Q 30/0601; G06F 16/958

(52) U.S. Cl. CPC G06Q 30/0605; G06F 16/958

(57) ABSTRACT

The disclosure provides methods of creating an online shopping mall consisting of websites having a single domain name extension including creating a website with the single domain name extension, creating a page on the online shopping mall website with the domain name without the single domain name extension, indexing the web site with a search engine, and redirecting the indexed domain name with the single domain name extension to the page on the online shopping mall website. The single domain name extension may be the “*.us” extension. The search engine may be Google™. The online shopping mall may include a subcategory of business entities. The subcategory may include a food court.

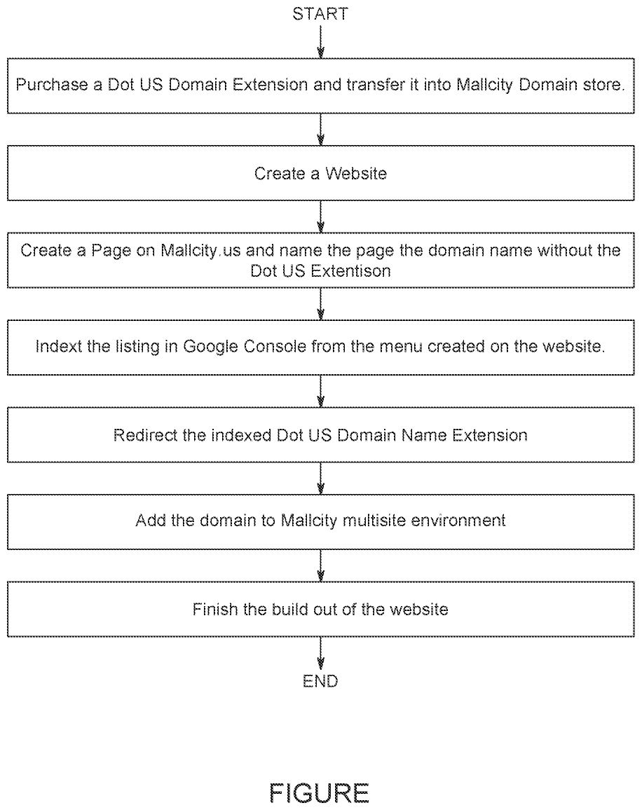

### CROSS REFERENCE TO RELATED APPLICATIONS

This application claims priority to U.S. provisional application No. 63/403,746 filed on Sep. 3, 2022, which is herein incorporated by reference in its entirety.

### BACKGROUND

### Description of the Related Art

Historically, there were a limited number of domain name extensions available on the Internet, such as, “.com”, for commercial websites, “.edu” for educational websites, “*.mil” from military websites, etc. in recent years, however, a large number of new domain name extensions have become available for use by the Internet Corporation for Assigned Names and Numbers (ICANN). On Jun. 20, 2011, ICANN ended most restrictions on the creation of generic top-level domain names (gTLDs)—at which time 22 gTLDs were available. Companies and organizations would be able to choose essentially arbitrary top-level Internet domains. The use of non-Latin characters (such as Cyrillic, Arabic, Chinese, etc.) would also be allowed. ICANN began accepting applications for new gTLDs on Jan. 12, 2012.

This presents the possibility of using specific domain name extensions for novel online website creation and marketing possibilities for Internet businesses.

### SUMMARY DISCLOSURE OF THE INVENTION

The present disclosure provides an online shopping mall including a series of online business entities each of which with a website having the same or single domain name extension. Typically, the single domain name extension will not be one of the common or widely used domain name extensions historically used for Internet websites, i.e., *.com, *.edu, *.net, *.mil.*.gov. In a preferred embodiment, the domain name extension is the *.us domain name.

Online business entities can thus create a website with a specific domain name and then obtain the domain name with the single domain name extension and add it to the online shopping mall. Results in search engines such as Google, Yahoo, Bing, etc., can then be redirected to the online shopping mall website and webpage your webpages with the single domain name extension.

The disclosure thus provides methods of creating an online shopping mall consisting of websites having a single domain name extension including creating a website with the single domain name extension, creating a page on the online shopping mall website with the domain name without the single domain name extension, indexing the web site with a search engine, and redirecting the indexed domain name with the single domain name extension to the page on the online shopping mall website. The single domain name extension may be the “*.us” extension. The search engine may be Google™. The online shopping mall may include a subcategory of business entities. The subcategory may include a food court.

Other features and aspects will be apparent from the following detailed description, the drawings, and the claims.

### BRIEF DESCRIPTION OF THE DRAWINGS

The FIGURE is a flowchart showing a method of creating an online shopping mall using domain name extensions according to the disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DISCLOSURE OF THE INVENTION

The following detailed description is provided to assist the reader in gaining a comprehensive understanding of the methods, products, and/or systems described herein. However, various changes, modifications, and equivalents of the methods, products, and/or systems described herein will be apparent to an ordinary skilled artisan.

### MODES FOR CARRYING OUT THE INVENTION

Domain name extensions (or top-level domains TLDs) are at the end of an Internet domain name. For example, the well-known “.com” domain name extension is typically used for most commercial websites. Historically, the number of domain name extensions or top-level domains were limited to a small number. For example, “.com”, “.org”, “.net”, “.edu”, etc. In recent years, however, the number of domain name extensions that are allowed has increased dramatically. For example, there are now hundreds of allowed top-level domain names available. Popular examples include country level domain name extensions, for example, “.us”.

The owner of a particular domain can thus obtain domain name extensions for a web address with more than one domain name extension. For example, the owner of a particular domain for a pizza restaurant might be: “tonyspizza.com”. The owner of this domain could also potentially obtain the domain “tonyspizza.us” or “tonyspizza.com.us” or “tonyspizza.us.com”, for example, to provide additional marketing opportunities. Any of the above can also be redirected a preferred website, for example, “tonyspizza.us” or “tonyspizza.com.”

When a business name is input into a search engine, for example, Yahoo, Google, Bing, TomTom, Yp.com, apple maps, etc., the business website along with a particular domain extension (for example “tonyspizza.com”) might appear in the search results. Thus, when a user clicks on the business name link, the link can redirect the user to a preferred or primary business entity website which may have a different domain name extension, for example, “.us”.

The present invention thus provides methods of creating an online shopping mall website using domain name extensions, including creating a website mall property that includes a form of a website including pages, subpages, inline frames, subdomains, subdirectories, mobile applications, landing pages, click funnels, and marketplace, etc. Individual web site properties can then be created using a common domain name extension for individual businesses and can then be linked to the website mall property interface through a website browser and Uniform Resource Locators.

### Glossary

A top-level domain (TLD) is one of the domains at the highest level in the hierarchical Domain Name System of the Internet. For all domains in lower levels, it is the last part of the domain name, that is, the last non empty label of a fully qualified domain name. See Generic top-level Domain, Wikipedia, the free encyclopedia, downloaded: Jul. 26, 2023, herein incorporated by reference. Historically the generic top-level domains were .com, .org, .net, .edu, .gov, and .mil. Many new top-level domains have been recently added. In embodiments, the inventive online shopping mall uses a domain name extension other than one of .com, .org, .net, .edu, .gov, .int, .arpa, and .mil. That is, it uses one of the newer more recent top level domains, particularly those that have become available since Jun. 20, 2011. Preferred are .us, .it, and .in.

Web indexing, or internet indexing, includes methods for indexing the contents of a website for a search engine. Search engines usually use keywords and metadata to provide a vocabulary for Internet or onsite searching. See web indexing, Wikipedia, the free encyclopedia, downloaded: Jul. 26, 2023.

A domain name generally identifies a website, email services, etc., and is used to identify such services provided through the Internet. In general, a domain name identifies a network domain or an Internet Protocol (IP) resource, such as a personal computer used to access the Internet, or a server computer. See domain name, Wikipedia, the free encyclopedia, downloaded: Jul. 26, 2023.

### EXAMPLES

In this example, the purchase of “.us” domain name extensions from Mallcity, LLC and/or the transfer of a “.us” domain extensions into Mallcity, LLC from another registrar will enable a business entity to join and promote products and/or services on the online shopping mall: Mallcity.us™.

Mallcity.us™ is a website property of Mallcity, LLC. A form of website such as pages, subpages, inline frames, subdomains, subdirectories, mobile applications, landing pages can be created for business entities who want to join the Mallcity online shopping mall and can link to the Mallcity.us website interface for the website browser and Uniform Resource Locators. Notarysigningagency.us™, Bragabond.us™, Mallcity.us™, animationproduction.us, and Morelove.us™ are examples of business entities names would be “business_entity.us”, i.e., the domain name along with a “.us” domain extension. This can be added to search engines through a process called search engine optimization.

Thus, when a business entity's name has been typed in or voice commanded in a search engine platform such as Yahoo™, Google™, Bing™, TomTom™, Yp.com™, Apple Maps™, etc., Mallcity.us™ along with a dot us domain extension then clicked on, the link redirects to the business entity storefront on the Mallcity.us™ catalog website, reading: Mallcity.us/with the business name attached following after the forward slash or back slash in the web browser.

A store in Mallcity.us™ can be used as a primary website and or an additional website. As an example, an entity that already has a website with a dot com, dot org, dot net, and so on (entity.com) can obtain a dot US domain extension (entity.us), advertise the business entity name with a dot US extension to represent their business presence in the United States, and become a part of an online collective shopping mall. Business entities that already have a dot US domain website but who do not wish to add the primary website to the mall can add a business name variation with the dot us domain name extension. As an example, “entity.us” can have “entity2.us” added to the mall.

Various iterations on the above can be implemented. Business entities that identify in a category such as an organization, educational, or internet can add the classification to the domain name extension in the following manner: “co.us”, “us.com”, “com.us”, “net.us”, “org.us”, “name.us”, “edu.us”, “mil.us”, “biz.us”, etc. Examples would include Mallcity.co.us, Morelove.us.com, Mallcity.com.us, Morelove.net.us, Mallcity.org.us, Morelove.name.us, Mallcity.edu.us, Morelove.mil.us, Mallcity.biz.us, etc.

Thus, Business name with dot US first and Mallcity.us following a forward slash, back slash, dot, and or hyphen in Browser list of examples would be: Business_Entity/Mallcity.us.

As another example, business names with dot us domain extension first and Morelove™ as a food court following the forward slash, back slash, dot, and or hyphen, then the food business name in Browser. For example: Mallcity.us/morelove/pizza_parlor; Mallcity.us/morelove/coffee_shop; Mallcity.us/morelove/cake_shop could create a food court within the online shopping mall. Other areas within the online shopping mall could be similarly created.

A form of a website listed above can be created per business entity to add a website in any visual technology, 3D, 2D, Virtual Reality, 4 k, Augmented reality, non-fungible tokens, motion pictures, standard Hypertext Markup Language. Any of the visual technologies on the Business Entities website in the mall can have its own unique webpage theme layout separate from any other business entity in Mallcity.us. A business entity can choose which visual technology development package fits best for the entity and can update the visual technology at any time.

A shopping cart system can be added to each website such as Walmart™, eBay™, Amazon.com™ and/or delivery check out cart system such as DoorDash™, UberEats™, Postmates™ Grubhub™, and Instacart™ can be used, for example, on a food court such as mallcity.us/morelove as disclosed above. Hot food restaurant gift cards can be purchased and used on Mallcity.us™ Customer purchases are delivered, in part or in totality, through any of the above services. When customers add products or services for check out the product or service will go to the above listings for purchase.

The invention can be implemented in digital electronic circuitry, or in computer hardware, firmware, software, or in one or more combinations. Apparatus of the invention can be implemented in a computer program product tangibly embodied in a machine-readable storage device for execution by a programmable processor; and one or more method steps in the invention can be performed by a programmable processor execution a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random-access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and optical disks. Any of the foregoing can be supplemented by, or incorporated in, ASICs (application-specific integrated circuits).

A computer system with which some embodiments of the invention are implemented includes a computer system including a bus, a processor, a system memory, a read-only memory, a permanent storage device, input devices, and output devices. In some embodiments, the computer system also includes a graphic processing unit (GPU).

The bus collectively represents all system, peripheral, and chipset buses that support communication among internal devices of the computer system. For instance, the bus communicatively connects the processor with the read-only memory, the system memory, and the permanent storage device.

From these various memory units, the processor (also referred to as central processing unit or CPU) retrieves instructions to execute and data to process in order to execute the processes of the invention. The read-only-memory (ROM) stores static data and instructions that are needed by the processor and other modules of the computer system.

The permanent storage device, on the other hand, is a read-and-write memory device. This device is a non-volatile memory unit that stores instruction and data even when the computer system is off. Some embodiments of the invention use a mass-storage device (such as a magnetic or optical disk and its corresponding disk drive) as the permanent storage device. The permanent storage device may be a fully solid-state storage, a conventional “spinning magnetic pallet” storage (i.e. hard-drive), or combinations thereof.

Other embodiments may use a removable storage device (such as a USB flash drive or SD Memory Card) as a temporary storage or as the permanent storage device.

Like the permanent storage device, the system memory is a read and write memory device. However, unlike storage device, the system memory is a volatile read-and-write memory, such as a random-access memory. The system memory stores at least some of the instructions and data that the processor needs at runtime.

Instructions and/or data needed to perform processes of some embodiments are stored in the system memory, the permanent storage device, the read-only memory, or any combination of the three. For example, the various memory units may contain instructions for processing multimedia items in accordance with some embodiments. From these various memory units, the processor retrieves instructions to execute and data to process in order to execute the processes of some embodiments.

The bus also connects to the input and output devices and. The input devices enable the user to communicate information and select commands to the computer system. The input devices include alphanumeric keyboards, touch panels, and cursor controllers. The input devices also include scanners through which an image can be input to the computer system. The output devices display images generated by the computer system. The output devices may include printers, pen plotters, laser printers, ink-jet plotters, film recorders, and display devices, such as cathode ray tubes (CRT), liquid crystal displays (LCD), or electroluminescent displays.

The bus also couples the computer to a network through a network adapter. In this manner, the computer can be a part of a network of computers (such as a local area network (“LAN”), a wide area network (“WAN”), or an Intranet) and/or a network of networks, i.e., the internet. Finally, the computer system in some embodiments also optionally includes a graphics processing unit (GPU). A GPU (also referred to as a visual processing unit or a display processor) is a dedicated graphics rendering device which is very efficient in manipulating and displaying computer graphics. The GPU can be included in a video card (not shown) or can be integrated into the mother board of the computer system along with the processor. Also, the computer system may be used as a personal computer, a workstation, a game console, or the like. Any or all of the components of computer system may be used in conjunction with the invention.

The FIGURE shows a flowchart showing a method of creating an online shopping mall using domain name extensions according to the disclosure.

Accordingly, methods of creating an online shopping mall using domain name extensions are provided as follows.

MALLCITY.US™ ONLINE SHOPPING MALL

Purchase a dot US (“.us”) domain name extension package from Mallcity.us™ and/or purchase from a domain store and transfer the domain to Mallcity.us™ or have the Domain and the domain extension pointed to the Mallcity.us™ servers, using the domain name extension “.us” in this example.

Create a website from the Mallcity.us™ Control Panel. This will enable the URL also known as the web address of the webpage to be found in the web browser.

Create a page on Mallcity.us™ by clicking add a page on an Admin panel.

Create a page drop down menu with clickable tabs, for example, pages named Home, Shop, Mall Main Entrance, Contact Us, and My Account can be created. When these menu links are clicked the link opens a page or website. Before clicking save page, name the page, i.e., the name of the Domain Name without the .us extension. Example domain name extension: “business_entity.us”, name the page “business_entity” so the web browser reads Mallcity.us/business_entity after save page is clicked.

Perform search engine optimization to add indexing, Metadata tag, slug of the Domain name for the search engine.

To redirect the domain name link listed in the search engines to the created named page on Mallcity.us. Example redirect: business_entity.us link to Mallcity.us/business_entity; open the Mallcity™ control panel; click on business_entity.us on the domains tab, click URL redirect record on the Type bar, enter www in the host bar, enter Mallcity.us/business_entity in the value bar and click save.

Add the domain name into the Mallcity™ multisite environment by clicking add new on the Sites tab and complete the build out of the website by adding content automation system, and shopping cart system.

MALLCITY.IN ONLINE SHOPPING MALL

Purchase a Domain extension package from Mallcity™ at shop.mallcity.in and or purchase from a domain extension store and transfer the domain name extension to Mallcity or have the Domain the domain extension pointed to the Mallcity™ servers records.

Click create a website on the Control Panel this will enable the URL also known as the web address of the webpage to be found in the web browser.

Create a page on Mallcity.in by clicking add a page on the Admin panel.

Create a page drop down menu with clickable tabs named Home, Shop, Mall Main Entrance, Contact Us, and My Account when these menu links are clicked the link opens a page or website. Before clicking save page, name the page the name of the Domain Name without the extension. Example domain name extension Bragabond.in, name the page Bragabond so the web browser reads Mallcity.in/Bragabond after save page is clicked.

Log in to Google Console to add indexing, Metadata tag, slug of the Domain Name for the Search Engine Optimization. As an example type in Bragabond.in in a search engine.

To redirect the domain name link listed in the search engines to the created named page on Mallcity.in. Example redirect Bragabond.in link to Mallcity.in/bragabond open the Mallcity control panel, click on Bragabond.in on the domains tab, click Url redirect record on the Type bar, enter www in the host bar, enter Mallcity.in/bragabond in the value bar and click save.

Add the domain name into the Mallcity™ multisite environment by clicking add new on the Sites tab.

Finish the build out of the website by adding content automation system, and shopping cart system.

MALLCITY.IT ONLINE SHOPPING MALL

Purchase a country code Domain extension package from Mallcity™ at shop.mallcity.it and or purchase from a domain extension store and transfer the domain name extension to Mallcity™ or have the Domain the domain extension pointed to the Mallcity™ servers records.

Click create a website on the Control Panel this will enable the URL also known as the web address of the webpage to be found in the web browser.

Create a page on Mallcity.in by clicking add a page on the Admin panel.

Create a page drop down menu with clickable tabs named Home, Shop, Mall Main Entrance, Contact Us, and My Account when these menu links are clicked the link opens a page or website. Before clicking save page, name the page the name of the Domain Name without the extension. Example domain name extension Bragabond.it, name the page Bragabond so the web browser reads Mallcity.it/Bragabond after save page is clicked.

Log in to Google Console to add indexing, Metadata tag, slug of the Domain Name for the Search Engine Optimization. As an example type in Bragabond.it in a search engine.

To redirect the domain name link listed in the search engines to the created named page on Mallcity.it. Example redirect Bragabond.it link to Mallcity.it/bragabond open the Mallcity control panel, click on Bragabond.it on the domains tab, click Url redirect record on the Type bar, enter www in the host bar, enter Mallcity.it/bragabond in the value bar and click save.

Add the domain name into the Mallcity™ multisite environment by clicking add new on the Sites tab.

Finish the build out of the website by adding content automation system, and shopping cart system.

Add tags on the hosting admin panel called search engine optimization Markup. This process enables adding pages to be found directly from a search engine.

While this disclosure includes specific examples, it will be apparent after an understanding of the disclosure of this application has been attained that various changes in form and details may be made in these examples without departing from the spirit and scope of the claims and their equivalents.

1. A method of creating an online shopping mall consisting of websites having a single domain name extension comprising:
creating a website with the single domain name extension;
creating a page on the online shopping mall website with the domain name without the single domain name extension;
indexing the web site with a search engine;
redirecting the indexed domain name with the single domain name extension to the page on the online shopping mall website;
adding the domain name with the single domain name extension to the online website.

2. The method of claim 1, wherein the single domain name extension is the “*.us” extension.

3. The method of claim 1, wherein the search engine is Google™.

4. The method of claim 1, wherein the online shopping mall comprises a subcategory of business entities.

5. The method of claim 1, wherein the subcategory comprises a food court.
